(19) United States
(12) Patent Application Publication
(10) Pub. No.: US 2026/0009947 A1
(43) Pub. Date: Jan. 8, 2026

(54) SUBSTRATE STRUCTURE WITH WAVEGUIDE INSIDE OF VIA AND MANUFACTURING METHOD THEREOF

(71) Applicant: Unimicron Technology Corp., Taoyuan City (TW)

(72) Inventors: Chun Hung KUO, Taoyuan City (TW); Kuo Ching Chen, Taoyuan City (TW); Yu Cheng Huang, Taoyuan City (TW); Heng Ming Nien, Taoyuan City (TW); Yu Hua Cheng, Taoyuan City (TW)

(21) Appl. No.: 18/805,029

(22) Filed: Aug. 14, 2024

(30) Foreign Application Priority Data
Jul. 4, 2024 (TW) 113125152

(51) Int. Cl. G02B 6/122; G02B 6/12; G02B 6/13

(52) U.S. Cl. CPC G02B 6/122; G02B 6/13; G02B 2006/12104

(57) ABSTRACT

A substrate structure with a waveguide inside of a via includes a core substrate layer. The core substrate layer includes a first surface and a second surface opposite to each other, and a via that communicates the two surfaces. A via metal layer is formed on an inner wall of the via, and the via includes a via channel that communicates the first surface and the second surface. An optical waveguide unit is formed in the via channel, and the optical waveguide unit includes a via optical waveguide. The substrate structure is utilized for transporting an electric signal through the via metal layer and a photonic signal through the via optical waveguide simultaneously through the same via, and thus conserving available space for forming vias on an optoelectronic substrate. This allows a transportation of the electric signal and the photonic signal to be more integrated.

### CROSS-REFERENCE TO RELATED APPLICATION(S)

This application claims the priority benefit of TW application serial No. filed on Jul. 4, 2024, the entirety of which is hereby incorporated by reference herein and made a part of the specification.

### BACKGROUND OF THE INVENTION

### 1. Field of the Invention

The present invention relates to a substrate structure and manufacturing method thereof, more particularly a substrate structure with waveguide inside of via and manufacturing method thereof.

### 2. Description of the Related Art

As technology evolves, more electronic components are in demands for transporting high frequency and high data transfer rate signals. In terms of a substrate, the substrate is also in demand for transporting high frequency and high data transfer rate signals by increasing input/output (I/O) port numbers, using fine pitch bonding for packaging, and apart from transporting an electric signal, additionally implementing an optical waveguide for transporting a photonic signal. By transporting both the electric signal and the photonic signal, the substrate is colloquially defined to be an optoelectronic substrate.

In order to transport both the electric signal and the photonic signal, a multi-layered optoelectronic substrate, such as a build-up substrate with a core layer, uses an electric signal circuit to transport the electric signal between layers through vias, and also separately uses a photonic circuit to transport the photonic signals through optical waveguides.

However, since the photonic signal and the electric signal are transported in different types of media, even though the photonic signal and the electric signal are integrated into the optoelectronic substrate, the photonic signal and the electric signal are in fact still following completely independent structural pathways for signal transportations. As a result, within a limited space of the optoelectronic substrate, a volume of the electric signal circuit limits a volume of the photonic circuit, and vice versa.

As the electric signal circuit and the photonic circuit struggle over the limited space of the optoelectronic substrate, and as I/O port numbers of the optoelectronic substrate are in demand to grow, the optoelectronic substrate must be structurally improved upon with better signal transportation pathways for more efficiently transporting the photonic signal and the electric signal.

### SUMMARY OF THE INVENTION

To overcome the aforementioned problems, the present invention provides a substrate structure with a waveguide inside of a via and manufacturing method thereof.

The substrate structure of the present invention includes:
a core substrate layer, comprising a first surface and a second surface opposite to each other;
a via, formed through the core substrate layer and communicating the first surface and the second surface, and comprising an inner wall;
a via metal layer, formed on the inner wall of the via, and leaving a via channel for the via; wherein the via channel communicates the first surface and the second surface; and
an optical waveguide unit, formed in the via channel and comprising a via optical waveguide.

The manufacturing method of the substrate structure of the present invention includes the following steps:
piercing a core substrate layer for forming a via communicating a first surface and a second surface of the core substrate layer; wherein the first surface and the second surface are opposite to each other, and the via includes an inner wall;
forming a via metal layer on the inner wall of the via, and leaving a via channel for the via; wherein the via channel also communicates the first surface and the second surface through the core substrate layer; and
forming an optical waveguide unit in the via channel; wherein the optical waveguide unit includes a via optical waveguide.

By forming a via metal layer and a via optical waveguide in the via, an electric signal is able to be transported across the via through the via metal layer, and a photonic signal is able to be simultaneously transported across the via through the via optical waveguide. In other words, the via of the present invention may simultaneously transport the electric signal through the via metal layer and transport the photonic signal through the via optical waveguide. As a result, the present invention saves space for laying out an electric circuit and a photonic circuit, and thus alleviates a struggle for independently laying out the electric circuit and the photonic circuit in a limited space of an optoelectronic substrate. The electric signal and the photonic signal are transported with greater integration across the via.

### BRIEF DESCRIPTION OF THE DRAWINGS

FIG. 1 is a cross-sectional perspective view of a substrate structure of the present invention.

FIG. 2 is a cross-sectional perspective view of a first embodiment of the substrate structure of the present invention.

FIGS. 3A to 3J are flow charts for a manufacturing method of the first embodiment of the substrate structure of the present invention.

FIG. 4 is a cross-sectional perspective view of a second embodiment of the substrate structure of the present invention.

FIGS. 5A to 5H are flow charts for a manufacturing method of the second embodiment of the substrate structure of the present invention.

FIG. 6 is another cross-sectional perspective view of the second embodiment of the substrate structure of the present invention.

FIG. 7 is a cross-sectional perspective view of a third embodiment of the substrate structure of the present invention.

FIGS. 8A to 8G are flow charts for a manufacturing method of the third embodiment of the substrate structure of the present invention.

FIGS. 9A to 9B are cross-sectional perspective views of the third embodiment of the substrate structure of the present invention.

### DETAILED DESCRIPTION OF THE INVENTION

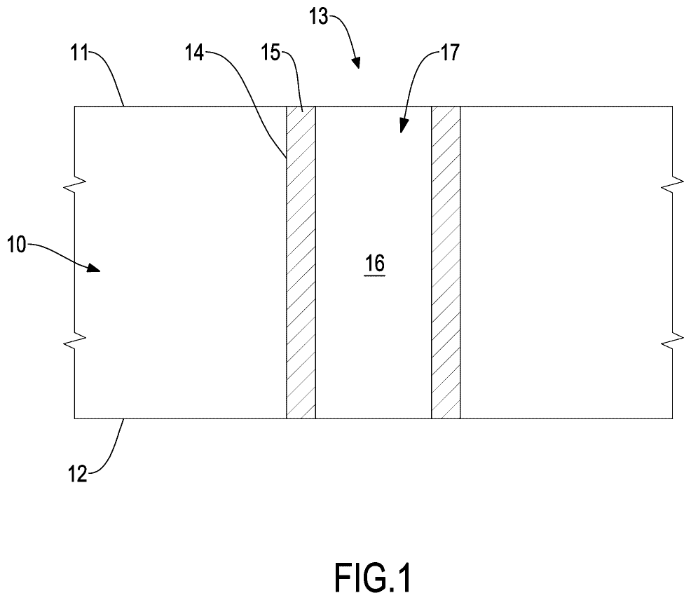

With reference to FIG. 1, the present invention provides a substrate structure with a waveguide inside of a via and a manufacturing method thereof. The present invention allows an electric signal and a photonic signal transport through a same passage for saving a layout space of a via in an optoelectronic substrate. The present invention alleviates a struggle for independently laying out an electric circuit and a photonic circuit in a limited space of the optoelectronic substrate, and thus allows the electric signal and the photonic signal to be transported with greater integration across the via.

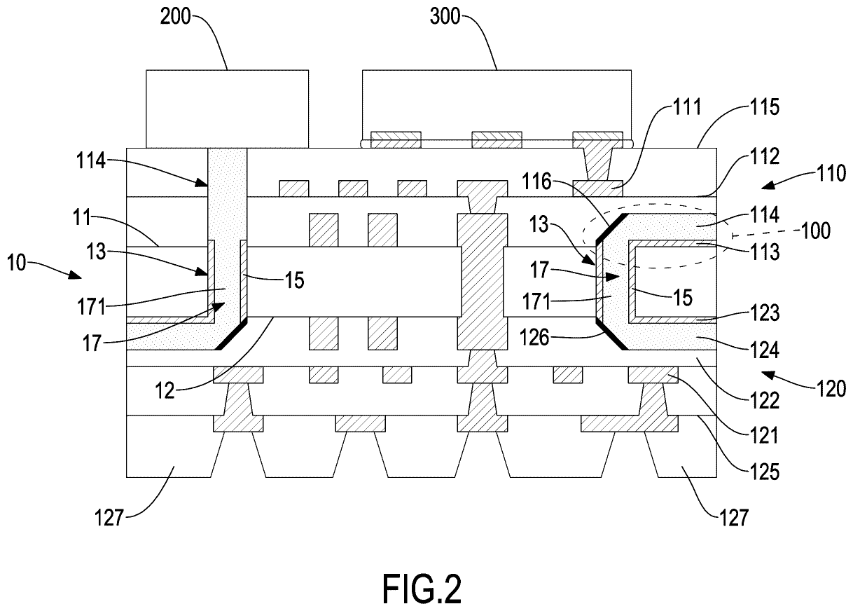

With reference to FIG. 1 and FIG. 2, FIG. 1 presents a cross-sectional perspective view of a core substrate layer 10 of an optoelectronic substrate. The core substrate layer 10 includes a first surface 11 and a second surface 12 opposite to each other. In an embodiment, the core substrate layer 10 is thick and strong enough to carry multiple layers of circuits that are respectively mounted on the first surface 11 and the second surface 12.

A via 13 is formed through the core substrate layer 10. The via 13 pierces the core substrate layer 10 for communicating the first surface 11 and the second surface 12, and the via 13 includes an inner wall 14. A via metal layer 15 is formed on the inner wall 14, and the via metal layer 15 is electrically conductive. However, the via metal layer 15 leaves a via channel 16 within the via 13 without completely filling up the via 13. An optical waveguide unit 17 is formed in the via channel 16, and the optical waveguide unit 17 includes a via optical waveguide 171.

By forming the via metal layer 15 and the via optical waveguide 171 in the via 13, an electric signal is able to be transported across the via 13 through the via metal layer 15, and a photonic signal is able to be simultaneously transported across the via 13 through the via optical waveguide 171. In other words, the via 13 of the present invention may simultaneously transport the electric signal through the via metal layer 15 and transport the photonic signal through the via optical waveguide 171. The via 13 saves space for laying out an electric circuit and a photonic circuit, and thus more space-efficiently transport the electric signal and the photonic signal over a limited space across the core substrate layer 10.

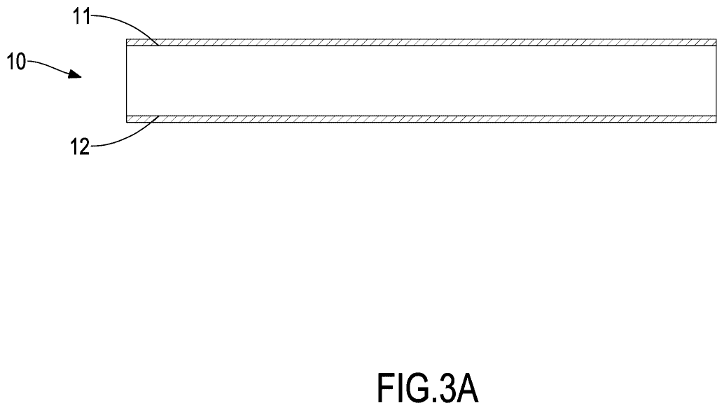

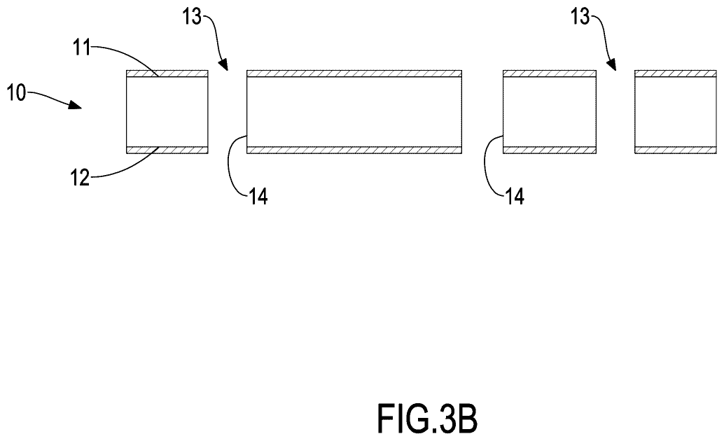

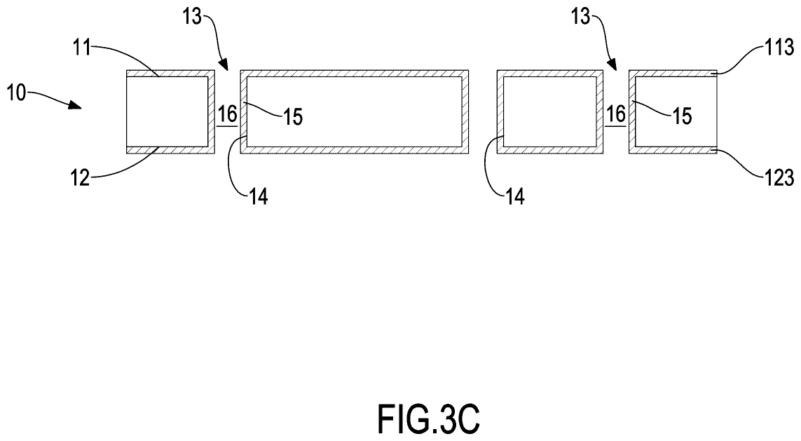

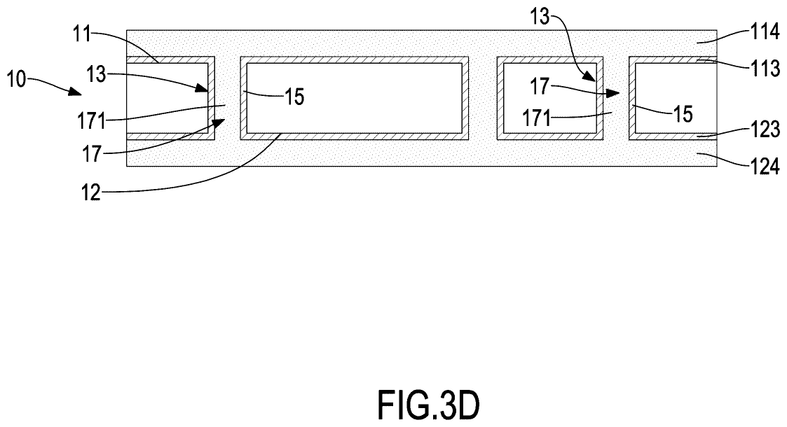

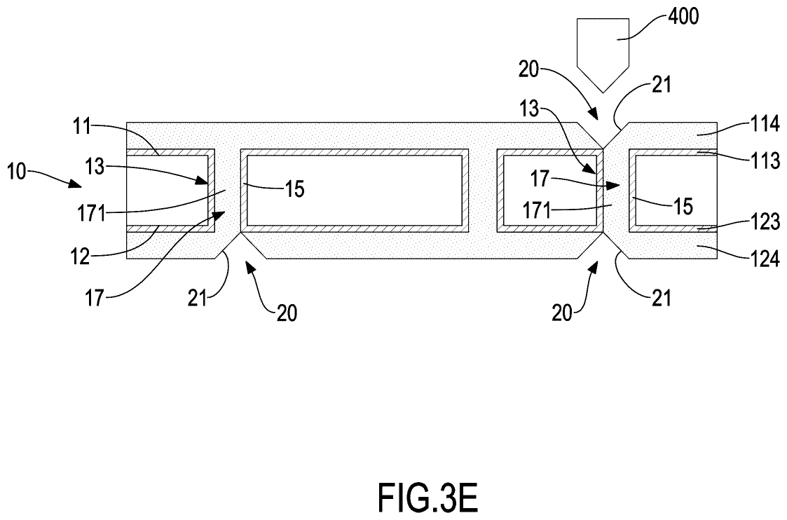

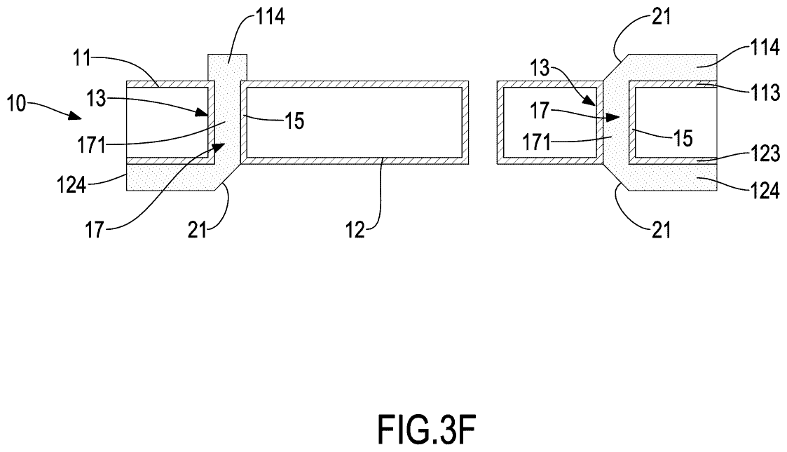

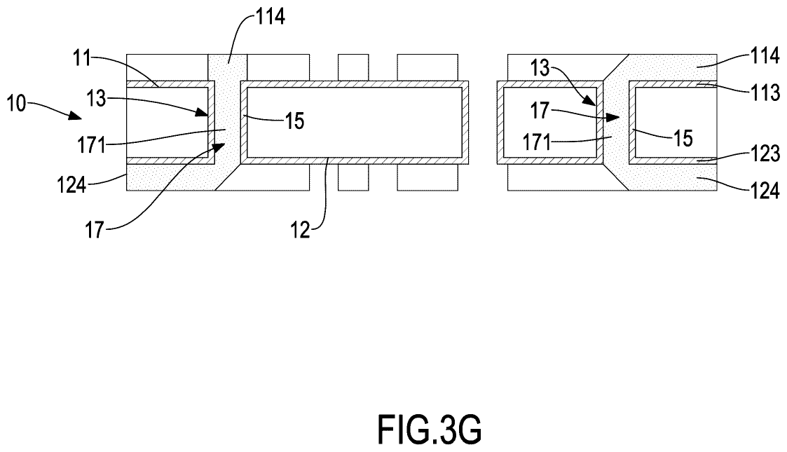

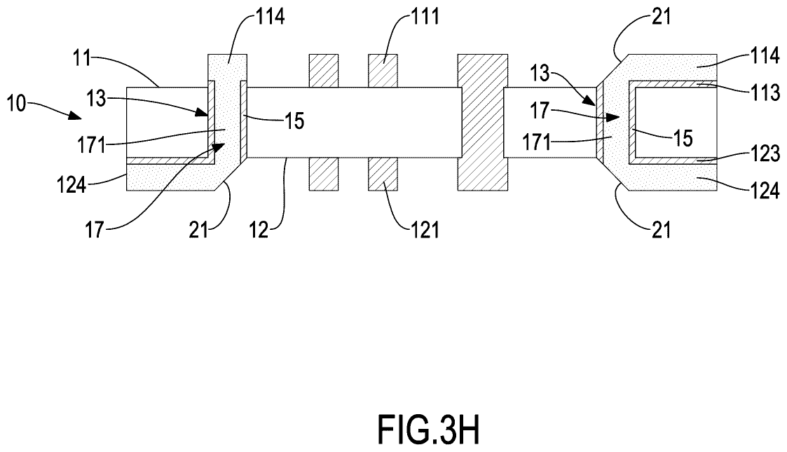

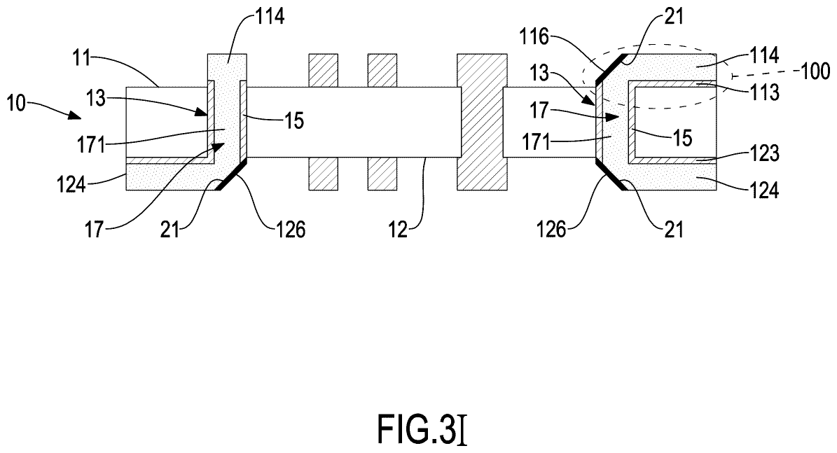

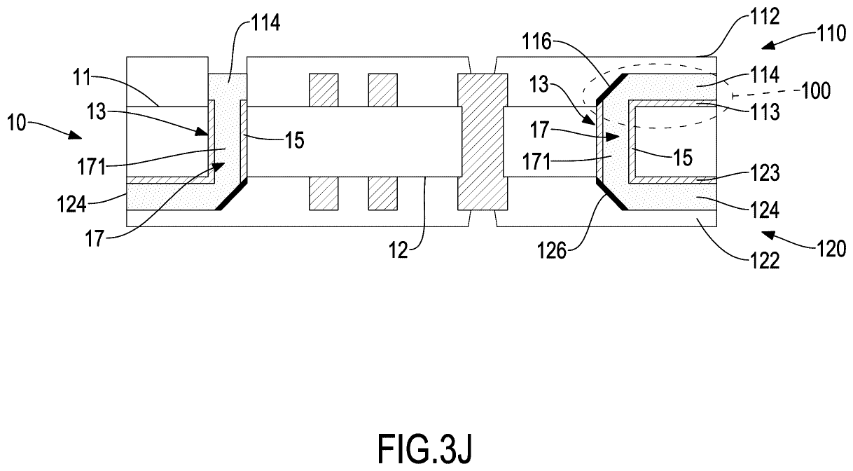

With reference to FIG. 2 and FIGS. 3A to 3J, FIG. 2 presents a cross-sectional perspective view of a first embodiment of the substrate structure of the present invention. The flow charts of FIGS. 3A to 3J present a manufacturing method for producing the substrate structure shown in FIG. 2.

In terms of refractive index (or index of refraction), according to Snell's Law, when a light beam travels from a medium of high refractive index to a medium of low refractive index, and when the light beam shines with an incident angle greater than or equal to a critical angle, total internal reflection would occur, restricting the light beam to only reflect and travel within the medium of high refractive index. Under such a circumstance, since the light beam only reflects and travels within a same medium, an intensity of the light beam is hardly lost from crossing a boundary into another medium.

To ensure a practical usefulness of transporting the photonic signal, in other words, to ensure that the photonic signal only reflects and travels within the via optical waveguide 171 when passing through the via 13 for minimizing energy loss of transporting the photonic signal, in the first embodiment, the via optical waveguide 171 directly contacts the via metal layer 15.

The substrate structure of the present invention further includes mounting a redistribution layer (RDL) respectively on the first surface 11 and the second surface 12 of the core substrate layer 10. Furthermore, at least one of the RDL includes a circuit dielectric layer, a circuit metal layer, and a circuit optical waveguide. For example, a first redistribution layer 110 is mounted on the first surface 11, and a second redistribution layer 120 is mounted on the second surface 12.

The first redistribution layer 110 includes a first circuit dielectric layer, a first circuit metal layer 113, a first circuit optical waveguide 114, a surface 115 of the first redistribution layer 110 that faces against the core substrate layer 10, and at least one reflective mirror 116. The first circuit dielectric layer includes a first electric circuit 111 and a first circuit dielectric 112, and the first circuit dielectric 112 covers the first electric circuit 111. The surface 115 of the first redistribution layer 110 is configured to mount an optoelectronic component 200 and an electronic component 300. The optoelectronic component 200 is configured to receive or output the photonic signal, and the electronic component 300 is configured to receive or output the electric signal.

The electronic component 300 is electrically connected to the first electric circuit 111 through pins of the electronic component 300 and corresponding pads for the pins. In an embodiment, the electronic component 300 is a die, and the electronic component 300 is electrically connected to the first circuit metal layer through the first electric circuit 111, and thus the electronic component 300 is further electrically connected to the via metal layer 15 through the first circuit metal layer 113. More particularly, a plurality of the vias 13 are formed on the core substrate layer 10, and the via metal layer 15 of each of the vias 13 is electrically connected to the first circuit metal layer 113. A part of the first circuit metal layer 113 is formed between the first circuit dielectric 112 and the core substrate layer 10. Such part of the first circuit metal layer 113 contacts the first surface 11 of the core substrate layer 10, and extends to connect the via metal layer 15 within one of the vias 13.

The first circuit optical waveguide 114 and the at least one reflective mirror 116 together form a photonic circuit within the first redistribution layer 110. The first circuit optical waveguide 114 is covered by the first circuit dielectric 112, and the first circuit optical waveguide 114 seamlessly connects the optoelectronic component 200 and the via optical waveguide 171 of each of the vias 13. Apart of the first circuit optical waveguide 114 contacts the first circuit metal layer 113. As shown in an area 100 in FIG. 2, the via optical waveguide 171 of one of the vias 13 is perpendicular to the first surface 11. By having one of the reflective mirrors 116 installed within the first circuit optical waveguide 114, the photonic signal transported by the first circuit optical waveguide 114 and the via optical waveguide 171 is able to make 90 degrees turn, and thus changing a traveling pathway of the photonic signal from being vertical from the first surface 11 to being parallel with the first surface 11. In an embodiment, the reflective mirrors 116 are installed with 45 degrees inclination with respect to the first surface 11. The photonic signal traveling in the area 100 contacts the first circuit dielectric 112 and the first circuit metal layer 113 as different media, and thus the photonic signal is reflected back into the first circuit optical waveguide 114.

Similarly, the second redistribution layer 120 includes a second circuit dielectric layer, a second circuit metal layer 123, a second circuit optical waveguide 124, a surface 125 of the second redistribution layer 120 that faces against the core substrate layer 10, and at least one reflective mirror 126. The second circuit dielectric layer includes a second electric circuit 121 and a second circuit dielectric 122, and the second circuit dielectric 122 covers the second electric circuit 121. Multiple pads 127 are mounted on the surface 125 of the second redistribution layer 120.

The second circuit metal layer 123 is electrically connected to the second electric circuit 121, and the second circuit metal layer 123 is also electrically connected to the via metal layer 15. More particularly, the via metal layer 15 of each of the vias 13 is electrically connected to the second circuit metal layer 123. A part of the second circuit metal layer 123 is formed between the second circuit dielectric 122 and the core substrate layer 10. Such part of the second circuit metal layer 123 contacts the second surface 12 of the core substrate layer 10, and extends to connect the via metal layer 15 within one of the vias 13.

The second circuit optical waveguide 124 and the at least one reflective mirror 126 together form a photonic circuit within the second redistribution layer 120. The second circuit optical waveguide 124 is covered by the second circuit dielectric 122, and the second circuit optical waveguide 124 seamlessly connects the via optical waveguide 171 of each of the vias 13. A part of the second circuit optical waveguide 124 contacts the second circuit metal layer 123.

In an embodiment, the second circuit metal layer 123 and the first circuit metal layer 113 are same media with same materials. The second circuit dielectric 122 and the first circuit dielectric 112 are same media with same materials. The photonic signal traveling in the second redistribution layer 120 contacts the second circuit dielectric 122 and the second circuit metal layer 123, and thus the photonic signal is reflected back into the second circuit optical waveguide 124. The via metal layer 15, the first circuit metal layer 113, and the second circuit metal layer 123 are all electrically conductive.

With reference to FIGS. 3A to 3J, the substrate structure of the first embodiment is manufactured through the following steps.

With reference to FIG. 3A, prepare a substrate for being the core substrate layer 10. The substrate may be a carrier board, and the substrate includes a first surface 11 and a second surface 12. The first surface 11 and the second surface 12 are opposite to each other, and in an embodiment, the first surface 11 and the second surface 12 each respectively already include a metal layer.

With reference to FIG. 3B, pierce the first surface 11 and the second surface 12 of the core substrate layer 10 for forming at least one via 13 through the core substrate layer 10 for communicating the first surface 11 and the second surface 12. In an embodiment, laser drilling is used for piercing the core substrate layer 10.

With reference to FIG. 3C, form a via metal layer 15 in each of the vias 13, and thus allow the via metal layer 15 to form on an inner wall 14 of each of the vias 13 while leaving a via channel 16 in each of the vias 13. For example, the via metal layer 15 may be formed in the via 13 by using plated through hole (PTH). In an embodiment, when forming the via metal layer 15 in the via 13, also simultaneously form a circuit metal layer on the first surface 11 and the second surface 12 of the core substrate layer 10. For example, electro-plate a first circuit metal layer 113 on the first surface 11, and electro-plate a second circuit metal layer 123 on the second surface 12, wherein both the first circuit metal layer 113 and the second circuit metal layer 123 are yet to be patterned.

With reference to FIG. 3D, cover the first circuit metal layer 113, cover the second circuit metal layer 123, and fill up the via channel 16 of each of the vias 13 with an optical waveguide core material. As a result, the via optical waveguide 171 of each of the vias 13 is formed in the via channel 16 of each of the vias 13. Furthermore, a foundation of forming the first circuit optical waveguide 114 is formed on the first surface 11, and a foundation of forming the second circuit optical waveguide 124 is formed on the second surface 12. In this step, the foundation of the first circuit optical waveguide 114 and the foundation of the second circuit optical waveguide 124 seamlessly connect the via optical waveguides 171 in the via channels 16. In an embodiment, the optical waveguide core material is a photosensitive material, such as a photoresist. The photosensitive material is used for filling up the via channels 16 and forming the via optical waveguides 171.

With reference to FIG. 3E, form at least one dent 20 by using a mold 400 respectively towards the foundation of the first circuit optical waveguide 114 and the foundation of the second circuit optical waveguide 124. In an embodiment, the first surface 11 and the second surface 12 are parallel to each other, and the at least one dent 20 is made by compression molding using the mold 400. A surface 21 of the dent 20 is formed to have 45 degrees decline with respect to the first surface 11.

With reference to FIG. 3F, respectively pattern the optical waveguide core material on the first surface 11 and the second surface 12 through photolithography, and thus pattern the foundation of the first circuit optical waveguide 114 and the foundation of the second circuit optical waveguide 124. In the present embodiment, after patterning, parts of the first circuit optical waveguide 114 are contacting the first circuit metal layer 113, and parts of the second circuit optical waveguide 124 are contacting the second circuit metal layer 123.

With reference to FIGS. 3G and 3H, use photoresist of photolithography to layout a designated area for depositing metal, and then deposit metal, remove excessive metal and remove the photoresist for leaving electric circuits that have been patterned. The electric circuits include a first electric circuit 111 and a second electric circuit 121, wherein the first electric circuit 111 is patterned on the first surface 11 and the second electric circuit 121 is patterned on the second surface 12. The first electric circuit 111 is electrically connected to the first circuit metal layer 113, and the second electric circuit 121 is electrically connected to the second circuit metal layer 123 (not shown in FIGS. 3G and 3H).

With reference to FIG. 3I, mount the reflective mirrors 116, 126 on the surfaces 21 of the dents 20. As a result, the photonic signal is able to be reflected by the reflective mirrors 116, 126 with 45 degrees of incident angle (angle of incidence) and reflective angle (angle of reflection). This enables the photonic signal to make a 90-degrees turn during its travel. In an embodiment, the reflective mirrors 116, 126 are metallic surfaces with curvatures.

With reference to FIG. 3J, compression mold dielectric materials, for example, form a first circuit dielectric 112 on the first surface 11 for covering the first circuit metal layer 113 and the first circuit optical waveguide 114, and form a second circuit dielectric 122 on the second surface 12 for covering the second circuit metal layer 123 and the second circuit optical waveguide 124. Furthermore, expose parts of the first circuit optical waveguide 114 from the first circuit dielectric 112 and expose parts of the second circuit optical waveguide 124 from the second circuit dielectric 122 through photolithography.

Lastly, by executing a semi-additive process (SAP) to build multiple layers of photonic circuit and electric circuits upon the structure shown in FIG. 3J, the first embodiment of the substrate structure shown in FIG. 2 is created. As SAP is already a known technique in substrate manufacturing industries, the present invention will hereby omit detailing the steps entailed by executing the SAP.

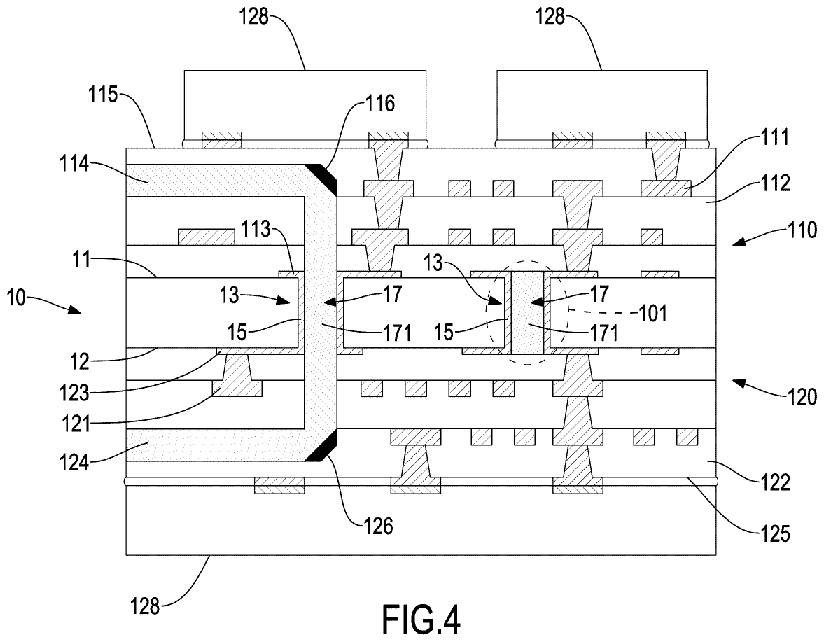

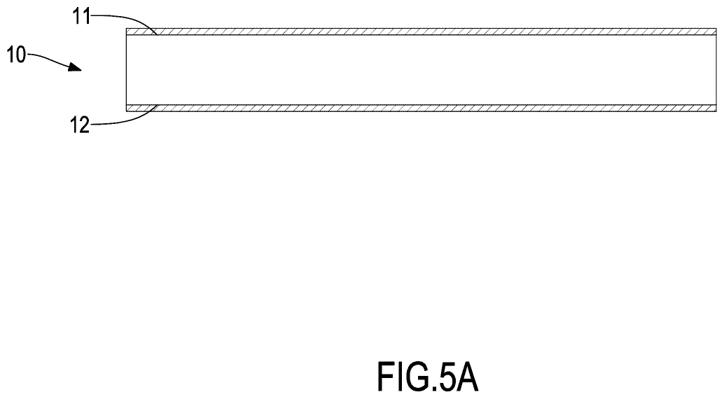

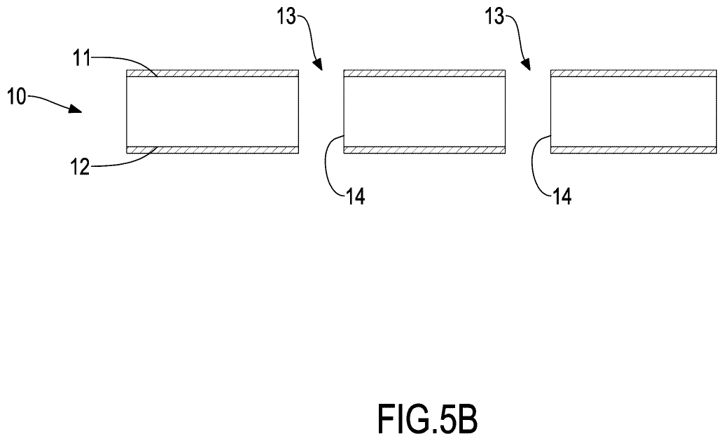

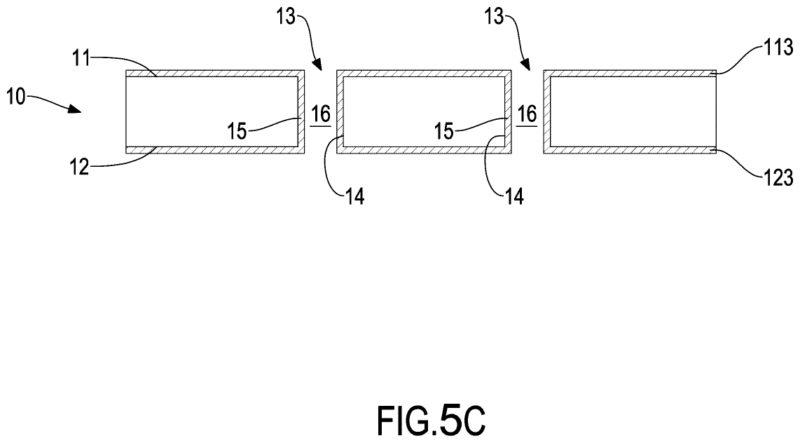

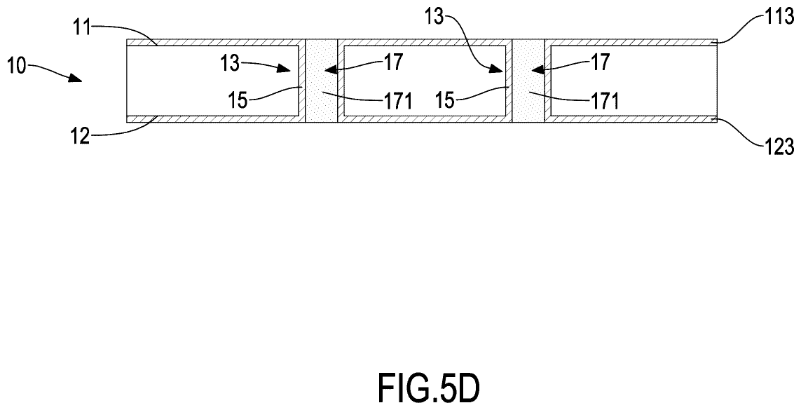

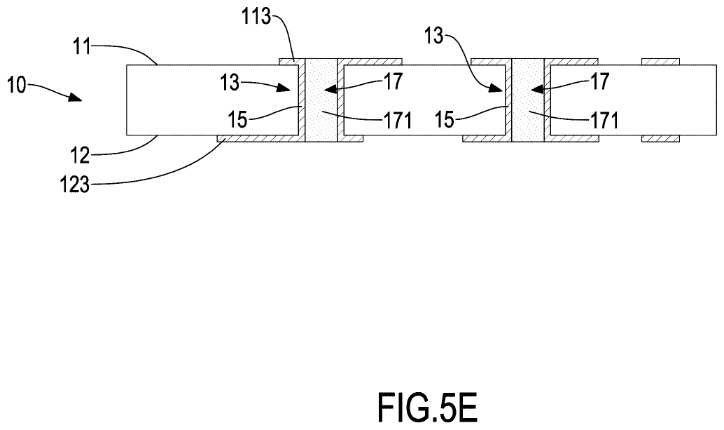

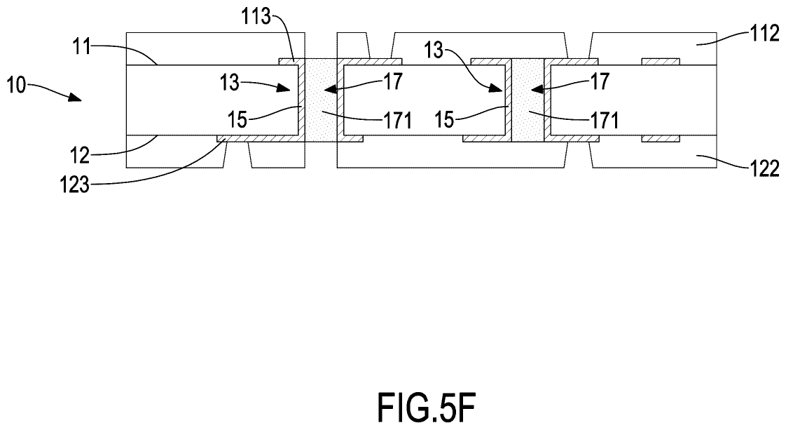

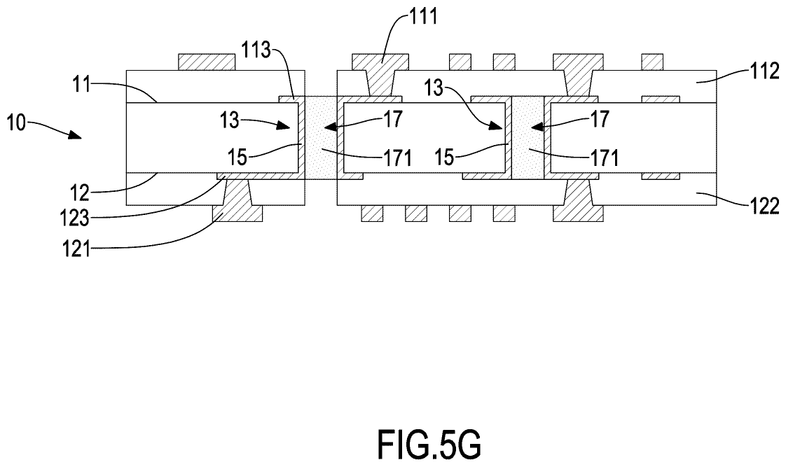

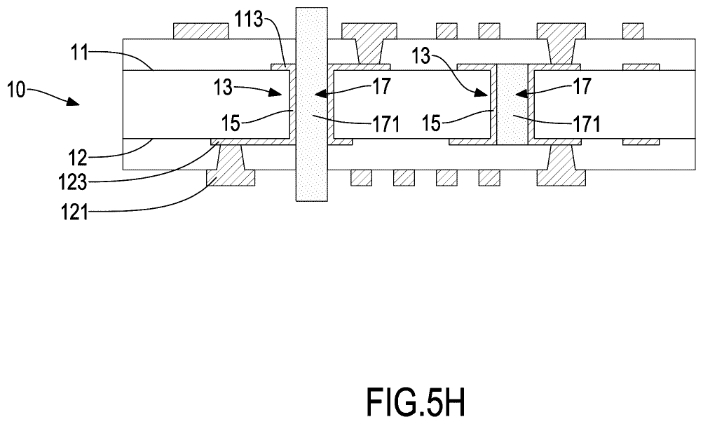

With reference to FIG. 4 and FIGS. 5A to 5H, FIG. 4 presents a cross-sectional perspective view of a second embodiment of the substrate structure of the present invention. The flow charts of FIGS. 5A to 5H present a manufacturing method for producing the substrate structure shown in FIG. 4.

With reference to FIG. 4, in the second embodiment, the substrate structure of the present invention further includes the first redistribution layer 110 and the second redistribution layer 120, wherein the first redistribution layer 110 is mounted on the first surface 11 of the core substrate layer 10, and the second redistribution layer 120 is mounted on the second surface 12 of the core substrate layer 10.

The first redistribution layer 110 includes the first circuit dielectric layer, the first circuit metal layer 113, the first circuit optical waveguide 114, the surface 115 of the first redistribution layer 110 that faces against the core substrate layer 10, and the at least one reflective mirror 116. The first circuit dielectric layer includes the first electric circuit 111 and the first circuit dielectric 112, and the first circuit dielectric 112 covers the first electric circuit 111. The surface 115 of the first redistribution layer 110 is configured to mount multiple circuit board components 128, and each of the circuit board components 128 is configured to receive or output electric signals.

One of the circuit board components 128 is electrically connected to the first electric circuit 111 mounted within the first circuit dielectric 112 through corresponding electrical contacts. One of the circuit board components 128 is electrically connected to the first circuit metal layer 113 through the first electric circuit 111, and further electrically connected to the via metal layer 15 through the first electric circuit 111. More particularly, a plurality of the vias 13 are formed on the core substrate layer 10, and the via metal layer 15 of each of the vias 13 is electrically connected to the first circuit metal layer 113. A part of the first circuit metal layer 113 is formed between the first circuit dielectric 112 and the core substrate layer 10. Such part of the first circuit metal layer 113 contacts the first surface 11 of the core substrate layer 10, and extends to connect the via metal layer 15 within one of the vias 13.

The first circuit optical waveguide 114 and the at least one reflective mirror 116 together form a photonic circuit within the first redistribution layer 110. The first circuit optical waveguide 114 is covered by the first circuit dielectric 112, and the first circuit optical waveguide 114 seamlessly connects one of the circuit board components 128 and the via optical waveguide 171 of each of the vias 13. The first circuit optical waveguide 114 is configured to transport the photonic signal outputted by a photonic signal generator component (not shown in FIG. 4). The via optical waveguide 171 of one of the vias 13 is perpendicular to the first surface 11. By having one of the reflective mirrors 116 installed within the first circuit optical waveguide 114, the photonic signal transported by the first circuit optical waveguide 114 and the via optical waveguide 171 is able to make 90 degrees turn, and thus changing a traveling pathway of the photonic signal from being vertical from the first surface 11 to being parallel with the first surface 11. In an embodiment, the reflective mirrors 116 are installed with 45 degrees inclination with respect to the first surface 11. Regardless of being reflected by the first circuit dielectric 112 or by the first circuit metal layer 113, the photonic signal would still stably maintain its pathway traveling through the first circuit optical waveguide 114.

The second redistribution layer 120 includes the second circuit dielectric layer, the second electric circuit 121, the second circuit dielectric 122, the second circuit metal layer 123, the second circuit optical waveguide 124, the surface 125 of the second redistribution layer 120 that faces against the core substrate layer 10, and the at least one reflective mirror 126. The second circuit dielectric layer includes the second electric circuit 121 and the second circuit dielectric 122, and the second circuit dielectric 122 covers the second electric circuit 121. Another one of the circuit board components 128 is further mounted on the surface 125 of the second redistribution layer 120. The circuit board components 128 mounted on the surface 125 of the second redistribution layer 120 are configured to carry the substrate structure of the present invention.

The second circuit metal layer 123 is electrically connected to the second electric circuit 121, and the second circuit metal layer 123 is electrically connected to the via metal layer 15. As such, the via metal layer 15 of each of the vias 13 is electrically connected to the second circuit metal layer 123. A part of the second circuit metal layer 123 is formed between the second circuit dielectric 122 and the core substrate layer 10. Such part of the second circuit metal layer 123 contacts the second surface 12 of the core substrate layer 10, and extends to connect the via metal layer 15 within one of the vias 13.

The second circuit optical waveguide 124 and the at least one reflective mirror 126 together form a photonic circuit within the second redistribution layer 120. The second circuit optical waveguide 124 is embedded in the second circuit dielectric 122, and the second circuit optical waveguide 124 seamlessly connects the via optical waveguide 171 of each of the vias 13. The second circuit optical waveguide 124 is configured to transport the photonic signal outputted by a photonic signal generator component (not shown in FIG. 4). Furthermore, the second circuit metal layer 123 and the first circuit metal layer 113 are media of a same material. The second circuit dielectric 122 and the first circuit dielectric 112 are media of a same material.

As shown in area 101 in FIG. 4, in the second embodiment, the via optical waveguides 171 in some of the vias 13 are disconnected from the first circuit optical waveguide 114 or the second circuit optical waveguide 124. This means that the via optical waveguides 171 that are disconnected from the first circuit optical waveguide 114 or the second circuit optical waveguide 124 are configured for other purposes other than transporting the photonic signal, such as configured for simply filling up some of the vias 13. In other words, traditionally, the vias 13 are usually filled with a via-plugging-ink for eliminating any remaining gaps in the vias 13. The present invention replaces the via-plugging-ink with the via optical waveguides 171 for filling up the vias 13. In terms of manufacturing efficiency, it is more time efficient and cost efficient to simply fill up the vias 13 with the via optical waveguides 171, and thus avoid executing an additional step and costing more to fill up the vias 13 with the via-plugging-ink. The via optical waveguides 171 are an insulator, and thus the via optical waveguides 171 are suitable for replacing a functionality of the via-plugging-ink. Moreover, when one of the vias 13 is to be converted into a part of the photonic circuit, the present invention avoids a need to first remove a filler within the said via 13, such as avoiding a need to first remove the via-plugging-ink from the via. The present invention may make use of the via optical waveguide 171 that is already formed inside of the via 13, without a need to modify the via optical waveguide 171 inside of the via 13. For this reason, using the via optical waveguide 171 to replace the via-plugging-ink provides additional practical benefits for the present invention.

With reference to FIGS. 5A to 5H, the substrate structure of the second embodiment is manufactured through the following steps.

With reference to FIG. 5A, prepare the substrate for being the core substrate layer 10. The substrate includes the first surface 11 and the second surface 12. The first surface 11 and the second surface 12 are opposite to each other, and the first surface 11 and the second surface 12 each respectively already include a metal layer.

With reference to FIG. 5B, pierce the first surface 11 and the second surface 12 of the core substrate layer 10 for forming at least one via 13 through the core substrate layer 10 for communicating the first surface 11 and the second surface 12. In an embodiment, laser drilling is used for piercing the core substrate layer 10.

With reference to FIG. 5C, form the via metal layer 15 in each of the vias 13, and thus allow the via metal layer 15 to form on the inner wall 14 of each of the vias 13 while leaving the via channel 16 in each of the vias 13. For example, the via metal layer 15 may be formed in the via 13 by using PTH. In an embodiment, when forming the via metal layer 15 in the via 13, also simultaneously electro-plate the first circuit metal layer 113 on the first surface 11, and electro-plate the second circuit metal layer 123 on the second surface 12, wherein both the first circuit metal layer 113 and the second circuit metal layer 123 are yet to be patterned.

With reference to FIG. 5D, form the via optical waveguide 171 in the via channel 16 of each of the vias 13. For example, inject an optical waveguide core material to the via channel 16 of each of the vias 13, and thus fill up the via channel 16 of each of the vias 13 with the optical waveguide core material. In an embodiment, the optical waveguide core material is a photosensitive material, such as a photoresist. The photosensitive material is used for filling up the via channels 16 and forming the via optical waveguides 171.

With reference to FIG. 5E, respectively pattern the first circuit metal layer 113 on the first surface 11 and the second circuit metal layer 123 on the second surface 12 through photolithography.

With reference to FIG. 5F, cover the via optical waveguides 171, the first circuit metal layer 113 on the first surface 11, and the second circuit metal layer 123 on the second surface 12 with a dielectric material, and pattern the dielectric material through photolithography. For example, form the first circuit dielectric 112 on the first surface 11 while exposing the first circuit metal layer 113, form the second circuit dielectric 122 on the second surface 12 while exposing the second circuit metal layer 123, and expose the via optical waveguide 171 inside of the at least one via 13 from the first circuit dielectric 112 and the second circuit dielectric 122.

With reference to FIG. 5G, deposit metal on the first surface 11 and the second surface 12, and pattern the deposited metal through another photolithography for forming the first electric circuit 111 on the first surface 11 and the second electric circuit 121 on the second surface 12, while exposing the via optical waveguide 171 inside of the at least one via 13. The first electric circuit 111 is electrically connected to the first circuit metal layer 113, and the second electric circuit 121 is electrically connected to the second circuit metal layer 123.

With reference to FIG. 5H, cover the via optical waveguide 171 with the optical waveguide core material, thus concealing the exposed parts of the via optical waveguide 171, and pattern the optical waveguide core material through another photolithography for forming circuit optical waveguides that seamlessly connect to the via optical waveguide 171 in the via channel 16; in other words, form the first circuit optical waveguide 114 and the second circuit optical waveguide 124 that seamlessly connect to the via optical waveguide 171.

Then, a series of manufacturing steps are performed, such as: respectively compressing another one of the dielectric material covering the first circuit optical waveguide 114 and the second circuit optical waveguide 124, patterning the dielectric material, compressing the optical waveguide core material, compressive molding the optical waveguide core material for forming the at least one dent 20, patterning the optical waveguide core material, installing the reflective mirror on the surface 21 of the at least one dent 20, compressing another one of the dielectric material, layering RDL with SAP, and thus finally forming the second embodiment of the substrate structure shown in FIG. 4.

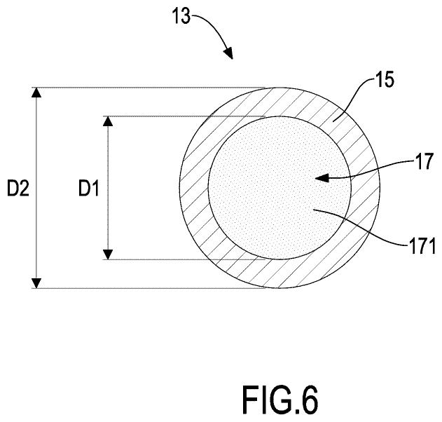

With reference to FIG. 6, FIG. 6 presents a cross-sectional perspective view along a direction parallel to the first surface 11 to show the via optical waveguide inside of the core substrate layer 10. The via optical waveguide 171 is surrounded by the via metal layer 15. In an embodiment, the via optical waveguide 171 and the via metal layer 15 together form a circle and a concentric ring. The via optical waveguide 171 has a via optical waveguide diameter D1, and the via metal layer 15 has a via metal layer diameter D2. A ratio of the via optical waveguide diameter D1 to the via metal layer diameter D2 can be any numeric value from 1:1.2 to 1:26. For example, the via metal layer diameter D2 more particularly has an inner diameter and an outer diameter. The inner diameter of the via metal layer diameter D2 has the previously mentioned 1:1.2 ratio with respect to the via optical waveguide diameter D1, and the outer diameter of the via metal layer diameter D2 has the previously mentioned 1:26 ratio with respect to the via optical waveguide diameter D1. In an embodiment, the via optical waveguide diameter D1 of the via optical waveguide 171 can be any numeric value from 5 microns (μm) to 100 μm.

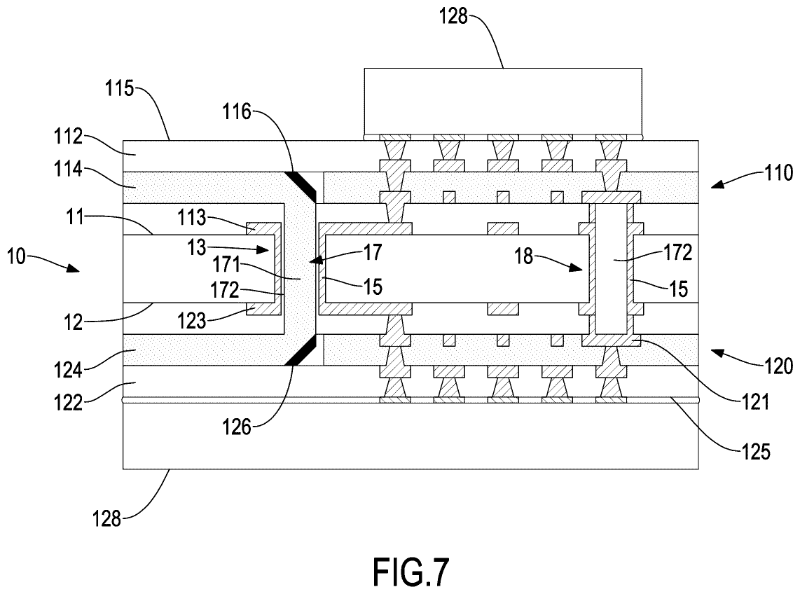

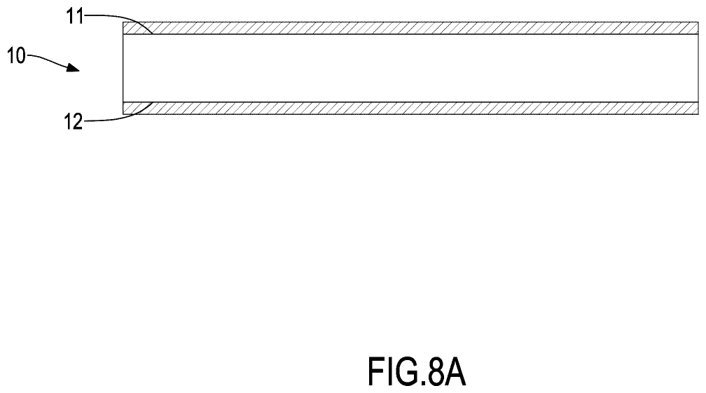

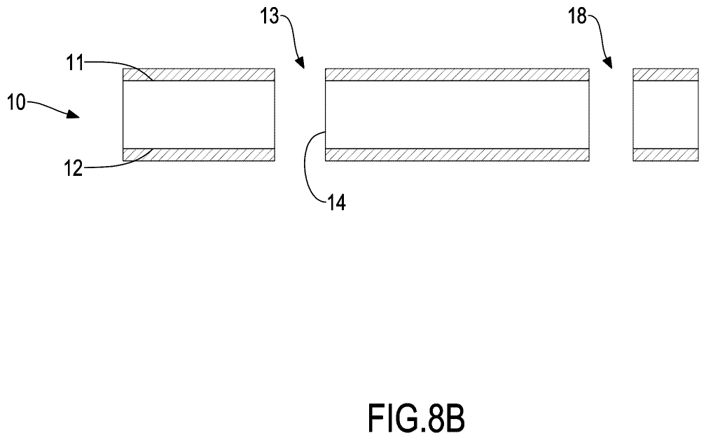

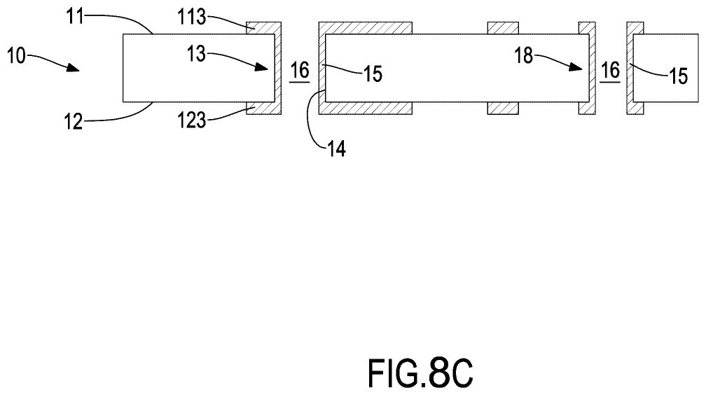

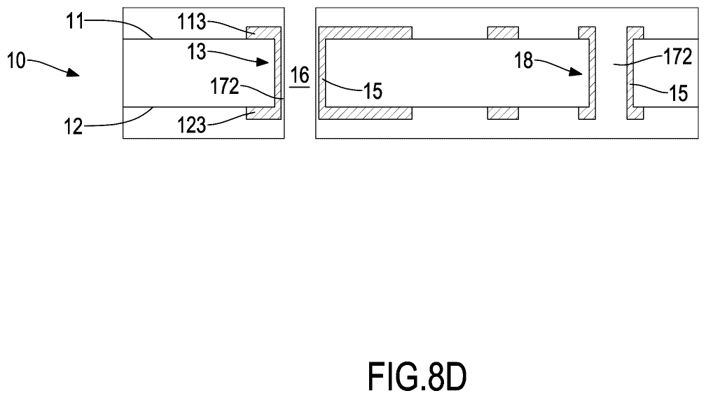

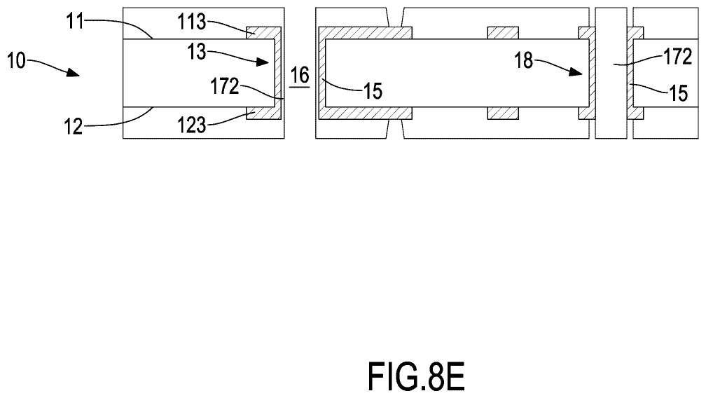

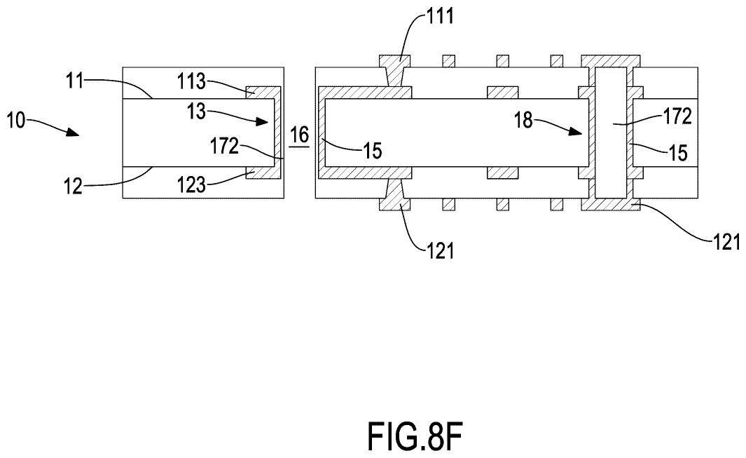

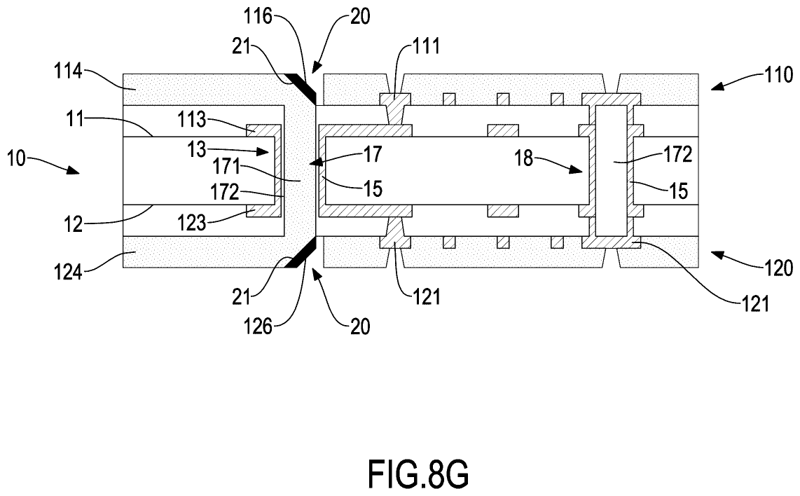

With reference to FIG. 7 and FIGS. 8A to 8G, FIG. 7 presents a cross-sectional perspective view of a third embodiment of the substrate structure of the present invention. The flow charts of FIGS. 8A to 8G present a manufacturing method for producing the substrate structure shown in FIG. 7.

With reference to FIG. 7, in the third embodiment, the substrate structure includes the first redistribution layer 110 that is mounted on the first surface 11 of the core substrate layer 10 and the second redistribution layer 120 that is mounted on the second surface 12 of the core substrate layer 10.

The first redistribution layer 110 includes a first circuit dielectric layer, the first circuit metal layer 113, the first circuit optical waveguide 114, the surface 115 of the first redistribution layer 110 that faces against the core substrate layer 10, and the at least one reflective mirror 116. The circuit board components 128 are mounted on the surface 115 of the first redistribution layer 110 for receiving or outputting the electric signal. The first circuit dielectric layer includes the first electric circuit 111 and the first circuit dielectric 112. The first circuit dielectric 112 covers the first electric circuit 111.

The circuit board components 128 are electrically connected to the first electric circuit 111 through its corresponding contacts. The circuit board components 128 are electrically connected to the first circuit metal layer 113 through the first electric circuit 111, and the circuit board components 128 are further electrically connected to the via metal layer 15 through the first circuit metal layer 113. More particularly, the at least one via 13 and at least one ordinary via 18 are formed through the core substrate layer 10. The via metal layer 15 of the at least one via 13 is electrically connected to the first circuit metal layer 113. A part of the first circuit metal layer 113 is formed between the first circuit dielectric 112 and the core substrate layer 10. Such part of the first circuit metal layer 113 contacts the first surface 11 of the core substrate layer 10, and extends to connect the via metal layer 15 within the at least one via 13.

In the present embodiment, the optical waveguide unit 17, apart from having the via optical waveguide 171, further includes a dielectric covering layer 172. The dielectric covering layer 172 covers the optical waveguide unit 171, and the dielectric covering layer 172 and the optical waveguide unit 171 together are formed in the via channel 16 of the via 13. As such, the dielectric covering layer 172 serves as a buffer between the via optical waveguide 171 and the via metal layer 15. The via optical waveguide 171 has an optical waveguide refractive index (index of refraction), and the dielectric covering layer 172 has a covering layer refractive index. To ensure the photonic signal can be successfully transported, the present embodiment limits that the optical waveguide refractive index of the via optical waveguide 171 is greater than the covering layer refractive index of the dielectric covering layer 172. As a result, the photonic signal that travels in the via 13, upon contacting the dielectric covering layer 172 would reflect back into the via optical waveguide 171.

On the other hand, the via metal layer 15 is also formed on an inner wall of the at least one ordinary via 18. However, unlike the via 13, the via metal layer of the at least one ordinary via 18 only covers the dielectric covering layer 172 in the at least one ordinary via 18. In other words, the at least one ordinary via 18 is only able to transport the electric signal and unable to transport the photonic signal. Since the dielectric covering layer 172 is already formed in the at least one ordinary via 18, the at least one ordinary via 18 avoids needing additional manufacturing steps to fill up any empty gaps with a via-plugging-ink. As such, the at least one ordinary via 18 cost efficiently replaces the via-plugging-ink with the dielectric covering layer 172, and time efficiently avoids needing additional manufacturing steps.

The first circuit optical waveguide 114 and the at least one reflective mirror 116 together form a photonic circuit within the first redistribution layer 110. The first circuit optical waveguide 114 is covered by the first circuit dielectric 112, and the first circuit optical waveguide 114 seamlessly connects the via optical waveguide 171 of the at least one via 13. The first circuit optical waveguide 114 is configured to transport the photonic signal. The via optical waveguide 171 of the at least one via 13 is perpendicular to the first surface 11. By having one of the reflective mirrors 116 installed within the first circuit optical waveguide 114, the photonic signal transported by the first circuit optical waveguide 114 and the via optical waveguide 171 is able to make 90 degrees turn, thus changing a traveling pathway of the photonic signal from being vertical from the first surface 11 to being parallel with the first surface 11. In an embodiment, the reflective mirrors 116 are installed with 45 degrees inclination with respect to the first surface 11.

In the present embodiment, the dielectric covering layer 172 and the first circuit dielectric 112 are media of a same material, and the first circuit dielectric 112 has a dielectric layer refractive index. In other words, the covering layer refractive index is equal to the dielectric layer refractive index, and the optical waveguide refractive index is greater than the covering layer refractive index and the dielectric layer refractive index.

The second redistribution layer 120 includes a second circuit dielectric layer, a second circuit metal layer 123, a second circuit optical waveguide 124, a surface 125 of the second redistribution layer 120 that faces against the core substrate layer 10, and at least one reflective mirror 126. The second circuit dielectric layer includes a second electric circuit 121 and a second circuit dielectric 122, and the second circuit dielectric 122 covers the second electric circuit 121. The circuit board components 128 are mounted on the surface 125 of the second redistribution layer 120, and the circuit board components 128 are configured to carry the substrate structure of the present invention. The second circuit metal layer 123 is electrically connected to the second electric circuit 121, and the second circuit metal layer 123 is electrically connected to the via metal layer 15. As a result, the via metal layer 15 of the at least one via 13 is electrically connected to the second circuit metal layer 123. A part of the second circuit metal layer 123 is formed between the second circuit dielectric 122 and the core substrate layer 10. Such part of the second circuit metal layer 123 contacts the second surface 12 of the core substrate layer 10, and extends to connect the via metal layer 15 within one of the vias 13.

The second circuit optical waveguide 124 and the at least one reflective mirror 126 together form a photonic circuit within the second redistribution layer 120. The second circuit optical waveguide 124 is embedded in the second circuit dielectric 122, and the second circuit optical waveguide 124 seamlessly connects the via optical waveguide 171 of the at least one via 13. The second circuit optical waveguide 124 is configured to transport the photonic signal. The second circuit dielectric 122 and the first circuit dielectric 112 are made of the same material.

With reference to FIGS. 8A to 8G, the third embodiment of the substrate structure is manufactured by the following steps.

With reference to FIG. 8A, prepare the substrate for being the core substrate layer 10. The substrate includes the first surface 11 and the second surface 12. The first surface 11 and the second surface 12 are opposite to each other, and the first surface 11 and the second surface 12 each respectively already include a metal layer.

With reference to FIG. 8B, piercing the first surface 11 and the second surface 12 of the core substrate layer 10 for forming at least one via 13 and the at least one ordinary via 18 through the core substrate layer 10 for communicating the first surface 11 and the second surface 12. In an embodiment, laser drilling is used for piercing the core substrate layer 10. Furthermore, a caliber of the at least one via 13 and a caliber of the at least one ordinary via 18 may be different.

With reference to FIG. 8C, form the via metal layer 15 in each of the vias 13, and thus allow the via metal layer 15 to form on the inner wall 14 of each of the vias 13 while leaving a via channel 16 in each of the vias 13. For example, the via metal layer 15 may be formed in the via 13 by using PTH. In an embodiment, when forming the via metal layer 15 in the via 13, also simultaneously form a circuit metal layer on the first surface 11 and the second surface 12 of the core substrate layer 10. For example, electro-plate a first circuit metal layer 113 on the first surface 11, and electro-plate a second circuit metal layer 123 on the second surface 12, and then pattern the first circuit metal layer 113 and the second circuit metal layer 123 through photolithography

With reference to FIG. 8D, completely cover the first surface 11, the second surface 12, the at least one via 13, and the at least one ordinary via 18 with the dielectric material.

With reference to FIG. 8E, pierce a part of the dielectric material in the via 13, and expose the first circuit metal layer 113 and the second circuit metal layer 123 through photolithography. As a result, the dielectric covering layer 172 is formed on the inner wall 14 of the via 13.

With reference to FIG. 8F, deposit metal on the first surface 11 and the second surface 12, and pattern the deposited metal through another photolithography for forming the first electric circuit 111 on the first surface 11 and the second electric circuit 121 on the second surface 12, while exposing the via channel 16 of at least one of the vias 13.

With reference to FIG. 8G, cover the first circuit metal layer 113, cover the second circuit metal layer 123, fill up the vias 13 with an optical waveguide core material, and pattern the optical waveguide core material through another photolithography. As a result, the via optical waveguide 171 covered by the dielectric covering layer 172 is formed in the via channel 16 of the vias 13. The circuit optical waveguide is also formed to seamlessly connect the via optical waveguide 171 in the via channel 16; in other words, the first circuit optical waveguide 114 and the second circuit optical waveguide 124 are formed to seamlessly connect the via optical waveguide 171 in the via channel 16.

Furthermore, a series of manufacturing steps are performed, such as: compressive molding the optical waveguide core material for forming the dents 20, installing the reflective mirrors 116, 126 on the surfaces 21 of the dents 20, respectively compressing another one of the dielectric material covering the first circuit optical waveguide 114 and the second circuit optical waveguide 124, patterning the dielectric material for exposing the first electric circuit 111 and the second electric circuit 121, depositing metal, extending the first electric circuit 111 and the second electric circuit 121 through another photolithography, layering RDL with SAP, and thus finally forming the third embodiment of the substrate structure shown in FIG. 7.

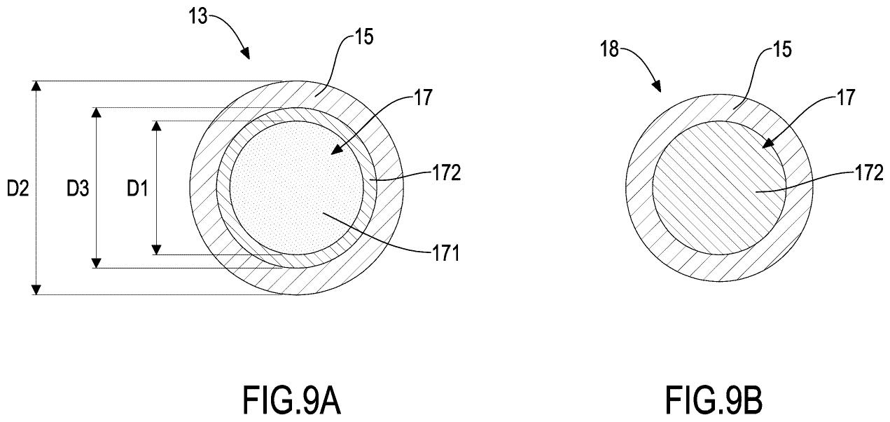

With reference to FIGS. 9A and 9B, FIG. 9A presents a cross-sectional perspective view along a direction parallel to the first surface 11 to show one of the vias 13 in the core substrate layer 10, and FIG. 9B presents a cross-sectional perspective view along the direction parallel to the first surface 11 to show one of the ordinary vias 18 in the core substrate layer 10. In an embodiment, in the via 13, the via optical waveguide 171, the dielectric covering layer 172, and the via metal layer 15 together form a circle and two concentric rings as shown in FIG. 9A. In the ordinary via 18, the dielectric covering layer 172 and the via metal layer 15 together form a circle and a concentric ring as shown in FIG. 9B.

With reference to FIG. 9A, the via optical waveguide 171 has the via optical waveguide diameter D1, the via metal layer 15 has the via metal layer diameter D2, and the dielectric covering layer 172 has a dielectric layer diameter D3. A ratio of the via optical waveguide diameter D1 to the dielectric layer diameter D3 and to the via metal layer diameter D2 can be any numeric value from 1:1.1:1.5 to 1:50:100.

For example, the dielectric layer diameter D3 more particularly has an inner diameter and an outer diameter. The inner diameter of the dielectric layer diameter D3 has the previously mentioned 1:1.1 ratio with respect to the via optical waveguide diameter D1, and the outer diameter of the dielectric layer diameter D3 has the previously mentioned 1:50 ratio with respect to the via optical waveguide diameter D1. The via metal layer diameter D2 also has an inner diameter and an outer diameter. The inner diameter of the via metal layer diameter D2 has the previously mentioned 1:1.5 ratio with respect to the via optical waveguide diameter D1, and the outer diameter of the via metal layer diameter D2 has the previously mentioned 1:100 ratio with respect to the via optical waveguide diameter D1. In an embodiment, the via optical waveguide diameter D1 of the via optical waveguide 171 can be any numeric value from 5 microns (μm) to 100 μm.

In conclusion, regarding the manufacturing method of the present invention, regardless of some differences between the multiple embodiments, all of the embodiments include the following identical manufacturing steps for creating the substrate structure with the waveguide inside of the via:
piercing the first surface 11 and the second surface 12 of the core substrate layer 10 for forming the via 13 through the core substrate layer 10 for communicating the first surface 11 and the second surface 12;
forming the via metal layer 15 on the inner wall 14 of the via 13 while leaving the via channel 16 for communicating the first surface 11 and the second surface 12 in the via 13;
forming the optical waveguide unit 17 in the via channel 16 of the via 13; wherein in some embodiments, the optical waveguide unit 17 only includes the via optical waveguide 171, and in some other embodiments, the optical waveguide unit 17 further includes the dielectric covering layer 172.

The substrate structure of the present invention improves upon a currently existing structure of an optoelectronic substrate by constructing the via 13 in the core substrate layer 10 that allows for the via optical waveguide 171 and the via metal layer 15 to pass, thus allowing the via optical waveguide 171 to transport the photonic signal and the via metal layer 15 to transport the electric signal simultaneously across the via 13. This improvement greatly saves space for laying out circuits within the limited confines of an optoelectronic substrate. Moreover, the manufacturing method of the present invention allows for time efficient and cost efficient production of the substrate structure, by filling up or plugging the vias 13 that are unused for circuit applications with dielectric materials or optical waveguide materials. This prevents a need for additionally filling up the vias 13 with a via-plugging-ink. By replacing the via-plugging-ink with the optical waveguide materials to fill up the vias 13, the present invention is able to designate the filled vias 13 as auxiliary pathways for the photonic signal to travel upon slight modifications to the photonic circuit. As the vias 13 are already filled with the optical waveguide materials, only slight modifications are required to integrate the vias 13, originally as auxiliary pathways, into the photonic circuit as in-use pathways. The slight modification only involves connecting the optical waveguide materials in the vias 13 to the first circuit optical waveguide 114 on the first surface 11 and to the second circuit optical waveguide 124 on the second surface 12 for transporting the photonic signal across the via 13. The slight modification avoids a need of removing any via-plugging-ink inside of a via, and thus the present invention allows for efficient modifications to the transportation pathways.

What is claimed is:

1. A substrate structure with a waveguide inside of a via, comprising:
a core substrate layer, comprising a first surface and a second surface opposite to each other;
a via, formed through the core substrate layer and communicating the first surface and the second surface, and comprising an inner wall;
a via metal layer, formed on the inner wall of the via, and leaving a via channel for the via; wherein the via channel communicates the first surface and the second surface; and
an optical waveguide unit, formed in the via channel and comprising a via optical waveguide.

2. The substrate structure as claimed in claim 1, wherein the via optical waveguide directly contacts the via metal layer.

3. The substrate structure as claimed in claim 2, further comprising:
a circuit metal layer, formed on the first surface of the core substrate layer, being electrically conductive, and connecting the via metal layer;
a circuit dielectric layer, formed on the circuit metal layer; and
a circuit optical waveguide, formed in the circuit dielectric layer, and seamlessly connecting the via optical waveguide;
wherein the circuit optical waveguide directly contacts the circuit metal layer.

4. The substrate structure as claimed in claim 1, wherein the optical waveguide unit comprises a dielectric covering layer;
wherein the dielectric covering layer covers the via optical waveguide, and is formed in the via channel of the via together with the via optical waveguide, thus allowing the dielectric covering layer to buffer the via optical waveguide and the via metal layer; and
wherein the dielectric covering layer has a covering layer refractive index, the via optical waveguide has an optical waveguide refractive index, and the optical waveguide refractive index is greater than the covering layer refractive index.

5. The substrate structure as claimed in claim 4, further comprising:
a circuit metal layer, formed on the first surface of the core substrate layer, being electrically conductive, and connecting the via metal layer;
a circuit dielectric layer, formed on the circuit metal layer; and
a circuit optical waveguide, formed in the circuit dielectric layer, and seamlessly connecting the via optical waveguide;
wherein the circuit optical waveguide and the circuit metal layer are formed with a distance apart from each other.

6. The substrate structure as claimed in claim 5, wherein the circuit dielectric layer has a dielectric layer refractive index, the circuit optical waveguide has the optical waveguide refractive index, and the optical waveguide refractive index is greater than the dielectric layer refractive index.

7. The substrate structure as claimed in claim 3, further comprising:
a reflective mirror, mounted in the circuit optical waveguide.

8. The substrate structure as claimed in claim 5, further comprising:
a reflective mirror, mounted in the circuit optical waveguide.

9. The substrate structure as claimed in claim 3, further comprising:
an electronic component, mounted on the circuit dielectric layer; wherein the circuit dielectric layer comprises an electric circuit and a dielectric material; the electric circuit electrically connects the electronic component and the via metal layer for transporting an electric signal between the electronic component and the via metal layer; the dielectric material covers the electric circuit; and
an optoelectronic component, mounted on the circuit dielectric layer; wherein the circuit optical waveguide connects the optoelectronic component and the via optical waveguide for transporting a photonic signal between the optoelectronic component and the via optical waveguide.

10. The substrate structure as claimed in claim 5, further comprising:
an electronic component, mounted on the circuit dielectric layer; wherein the circuit dielectric layer comprises an electric circuit and a dielectric material; the electric circuit electrically connects the electronic component and the via metal layer for transporting an electric signal between the electronic component and the via metal layer; the dielectric material covers the electric circuit; and
an optoelectronic component, mounted on the circuit dielectric layer; wherein the circuit optical waveguide connects the optoelectronic component and the via optical waveguide for transporting a photonic signal between the optoelectronic component and the via optical waveguide.

11. A manufacturing method for a substrate structure with a waveguide inside of a via, comprising the following steps:
piercing a core substrate layer for forming a via communicating a first surface and a second surface of the core substrate layer; wherein the first surface and the second surface are opposite to each other, and the via comprises an inner wall;
forming a via metal layer on the inner wall of the via, and leaving a via channel for the via; wherein the via channel also communicates the first surface and the second surface through the core substrate layer; and
forming an optical waveguide unit in the via channel; wherein the waveguide unit comprises a via optical waveguide.

12. The manufacturing method as claimed in claim 11, wherein when forming the via metal layer on the inner wall of the via, a circuit metal layer is also respectively formed on the first surface and the second surface of the core substrate layer.

13. The manufacturing method as claimed in claim 12, wherein the step of forming the optical waveguide unit in the via channel comprises the following sub-steps:
covering the circuit metal layer on the first surface, covering the circuit metal layer on the second surface, and filling up the via channel in the via with an optical waveguide core material;
respectively patterning the optical waveguide core material on the first surface and on the second surface through photolithography, and respectively forming a circuit optical waveguide on the first surface and on the second surface for seamlessly connecting the via optical waveguide; wherein one of the circuit optical waveguides on the first surface and on the second surface directly contacts the circuit metal layer; and
covering the circuit metal layer and the circuit optical waveguide with a dielectric material.

14. The manufacturing method as claimed in claim 12, wherein the step of forming the optical waveguide unit in the via channel comprises the following sub-steps:
filling up the via channel in the via with an optical waveguide core material for forming the via optical waveguide in the via channel;
respectively patterning the circuit metal layer on the first surface and the second surface through photolithography;
covering the via optical waveguide, and the circuit metal layer on the first surface and the second surface with a dielectric material, and exposing the via optical waveguide by patterning the dielectric material through another photolithography;
covering the via optical waveguide with an optical waveguide core material, and patterning the optical waveguide core material through another photolithography for forming a circuit optical waveguide that is seamlessly connecting the via optical waveguide in the via channel; and
covering the circuit optical waveguide with another layer of the dielectric material.

15. The manufacturing method as claimed in claim 12, wherein the step of forming the optical waveguide unit in the via channel comprises the following sub-steps:
respectively patterning the circuit metal layer on the first surface and the second surface through photolithography;
respectively covering the circuit metal layer on the first surface and the second surface with a dielectric material, and filling up the via channel in the via with the dielectric material;
piercing a part of the dielectric material inside of the via channel through another photolithography for forming a dielectric covering layer on the inner wall of the via;
covering the circuit metal layer on the first surface, covering the circuit metal layer on the second surface, and filling up the via with an optical waveguide core material, thus forming the via optical waveguide in the via channel of the via that is covered by the dielectric covering layer;
respectively patterning the optical waveguide core material on the first surface and on the second surface through another photolithography, thus respectively forming a circuit optical waveguide on the first surface and on the second surface that seamlessly connect the via optical waveguide in the via channel; and
respectively covering the circuit optical waveguide on the first surface and the circuit optical waveguide on the second surface with another layer of the dielectric material.

16. The manufacturing method as claimed in claim 13, wherein before the circuit optical waveguide is covered by the dielectric material, the method further comprises the following steps:
compressive molding a dent on the circuit optical waveguide by using a mold; wherein a surface of the dent is formed, and the surface of the dent has 45 degrees inclination with respect to the first surface of the core substrate layer; and
mounting a reflective mirror on the surface of the dent.

17. The manufacturing method as claimed in claim 14, wherein before the circuit optical waveguide is covered by the dielectric material, the method further comprises the following steps:
compressive molding a dent on the circuit optical waveguide by using a mold; wherein a surface of the dent is formed, and the surface of the dent has 45 degrees inclination with respect to the first surface of the core substrate layer; and
mounting a reflective mirror on the surface of the dent.

18. The manufacturing method as claimed in claim 15, wherein before the circuit optical waveguide is covered by the dielectric material, the method further comprises the following steps:
compressive molding a dent on the circuit optical waveguide by using a mold; wherein a surface of the dent is formed, and the surface of the dent has 45 degrees inclination with respect to the first surface of the core substrate layer; and
mounting a reflective mirror on the surface of the dent.
